(19) United States
(12) Patent Application Publication
(10) Pub. No.: US 2026/0332191 A1
(43) Pub. Date: Oct. 22, 2026

(54) MULTI-INPUT MULTI-OUTPUT COMMUNICATION SYSTEM AND TRANSMITTING DEVICE THEREOF

(71) Applicant: Alpha Networks Inc., Hsinchu (TW)

(72) Inventors: Wen-Jiunn TSAY, Hsinchu (TW); Tzong-Shiann YANG, Hsinchu (TW)

(21) Appl. No.: 19/323,825

(22) Filed: Sep. 9, 2025

(30) Foreign Application Priority Data
Apr. 18, 2025 (TW) 114114806

(51) Int. Cl. H04B 7/0413

(52) U.S. Cl. CPC H04B 7/0413

(57) ABSTRACT

A transmitting device of a MIMO communication system communicates with multiple receiving antennas, each having a polarization in a receiving-end direction. The transmitting device includes multiple transmitting antenna groups, each including two transmitting antennas transmitting transmitted signals in transmitted-end directions of orthogonal polarizations, and a blocking device disposed between the transmitting antenna groups. A matching transmission path is formed between the transmitting antenna and a matching one of the receiving antennas having identical polarizations in the transmitted-end direction and the receiving-end direction, where the transmitted signal transmitted by the transmitting antenna propagates through the matching transmission path. A non-matching transmission path is formed between the transmitting antenna and a non-matching one of the receiving antennas having different polarizations in the transmitting-end direction and the receiving-end direction. The blocking device is configured to block the non-matching transmission path.

### CROSS-REFERENCE TO RELATED APPLICATION

This application claims priority to Taiwanese Invention Patent Application No. 114114806, filed on Apr. 18, 2025, the entire disclosure of which is incorporated by reference herein.

### FIELD

The disclosure relates to a multi-input multi-output (MIMO) communication system and a transmitting device thereof, and more particularly to a MIMO communication system with reduced signal interference and a transmitting device thereof.

### BACKGROUND

In a multi-input multi-output (MIMO) system, a transmitting end includes multiple transmitting antennas for independently transmitting carrier signals, and a receiving end includes multiple receiving antennas for receiving the carrier signals. In some cases, the carrier signals (e.g., space-division multiplexing (SDM) carrier signals) may be directed to specific receiving antennas through beamforming, thereby improving transmission efficiency through parallel communication.

However, if the signal frequencies and transmission paths of the transmitting antennas of the transmitting end are strongly correlated, interference may occur, causing the receiving antennas to be unable to identify the carrier signals or to incorrectly decode the carrier signals. A conventional method is to use a polling mechanism to coordinate timing of signal transmissions, thereby preventing carrier signals that have strong correlation between signal frequencies and transmission paths from being transmitted simultaneously. However, although interference is reduced, the data throughput is also reduced.

### SUMMARY

Therefore, an object of the disclosure is to provide a transmitting device of a multi-input multi-output (MIMO) communication system that can alleviate at least one of the drawbacks of the prior art.

According to the disclosure, a transmitting device of a MIMO communication system is adapted for communicating with a plurality of receiving antennas, where each of the receiving antennas has a polarization in a receiving-end direction. The transmitting device includes a plurality of transmitting antenna groups and a blocking device that is disposed between the transmitting antenna groups. Each of the transmitting antenna groups includes two transmitting antennas, where each of the transmitting antennas has a polarization in a transmitting-end direction and is configured to transmit a transmitted signal with the polarization in the transmitting-end direction. The transmitting-end direction of the polarization of one of the transmitting antennas included in one of the transmitting antenna groups is orthogonal to the transmitting-end direction of the polarization of another one of the transmitting antennas included in the one of the transmitting antenna groups. The blocking device has a predetermined dimension along a propagation direction of the transmitted signals respectively transmitted by the transmitting antennas. For each of the transmitting antennas, the transmitting-end direction of the polarization of the transmitted signal is identical to the receiving-end direction of the polarization of one of the receiving antennas. For each of the transmitting antennas, a matching transmission path is formed between the transmitting antenna and a matching one of the receiving antennas that has the polarization in the receiving-end direction identical to the transmitting-end direction of the polarization of the transmitting antenna, and the transmitted signal transmitted by the transmitting antenna propagates through the matching transmission path. For each of the transmitting antennas, a non-matching transmission path is formed between the transmitting antenna and a non-matching one of the receiving antennas that has the polarization in the receiving-end direction not identical to the transmitting-end direction of the polarization of the transmitting antenna. The blocking device is configured to block the non-matching transmission path.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a multi-input multi-output (MIMO) communication system according to an embodiment of the disclosure.

FIG. 2 is a schematic view illustrating orthogonal polarizations of transmitted signals that are transmitted by a transmitting antenna group of the MIMO communication system.

FIG. 3 is a schematic view illustrating sixteen signal transmission paths of the MIMO communication system according to an embodiment of the disclosure.

FIG. 4 is a schematic view illustrating a blocking device blocking a plurality of non-matching transmission paths according to an embodiment of the disclosure.

FIG. 5 is a top perspective view illustrating the MIMO communication system with two antenna arrays and a blocking device disposed in a housing according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

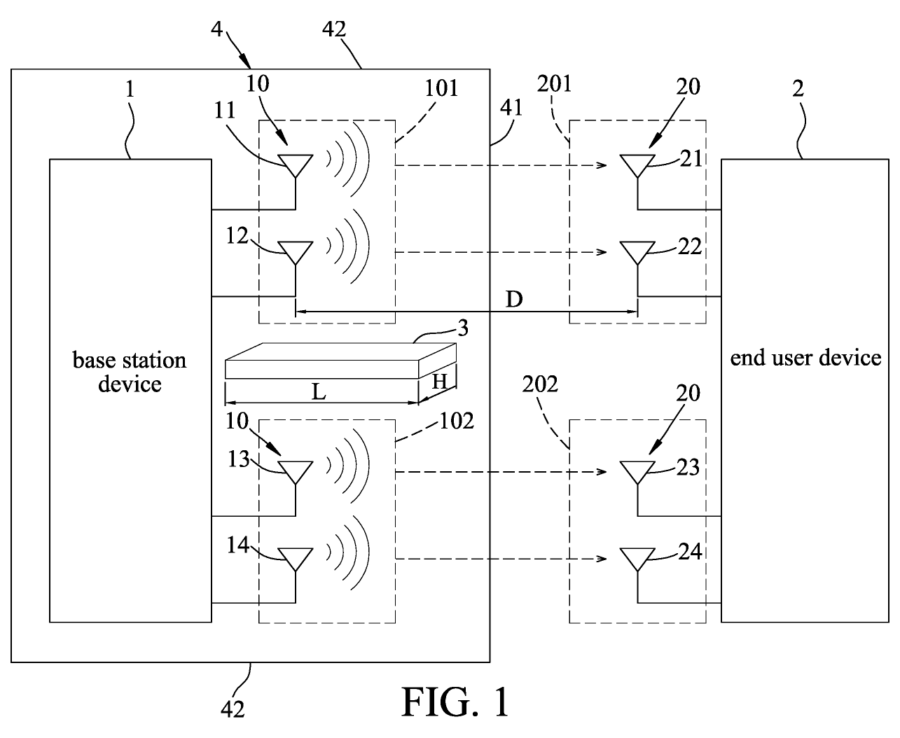

Referring to FIG. 1, according to an embodiment of the disclosure, a multi-input multi-output (MIMO) communication system includes a base station device 1, an end user device 2, a blocking device 3, and a housing 4 that accommodates the base station device 1 and the blocking device 3. The base station device 1 includes a plurality of transmitting antenna groups 101, 102, where each of the transmitting antenna groups 101, 102 includes a plurality of transmitting antennas 10. The end user device 2 includes a plurality of receiving antennas 20. In this embodiment, the MIMO communication system is exemplified as a 4x4 MIMO system (i.e., there are four transmitting antennas 10 and four receiving antennas 20), but the disclosure is not limited to such. In other embodiments, a number of the transmitting antennas 10 and a number of the receiving antennas 20 may vary. In this embodiment, the four transmitting antennas 10 are grouped into two transmitting antenna groups 101, 102, and the four receiving antennas 20 are grouped into two receiving antenna groups 201, 202.

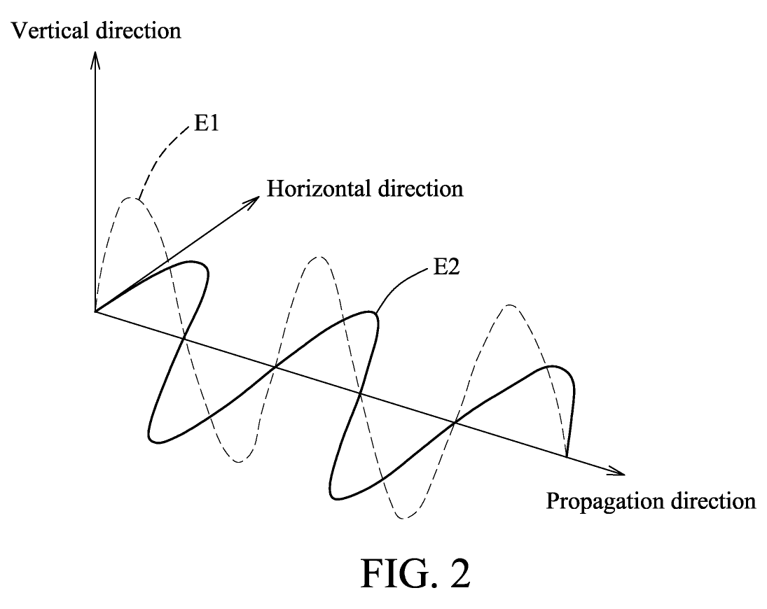

In each of the transmitting antenna groups 101, 102, each of the transmitting antennas 10 has a polarization in a transmitting-end direction, and is configured to transmit a transmitted signal with the polarization in the transmitting-end direction. Specifically, the transmitting-end direction of the polarization of one of the transmitting antennas 10 included in one of the transmitting antenna groups 101, 102 is orthogonal to the transmitting-end direction of the polarization of another one of the transmitting antennas 10 included in the same one of the transmitting antenna groups 101, 102. To describe in further detail, polarizations of transmitted signals being orthogonal to each other means that the oscillation directions of the electric fields of the transmitted signals are perpendicular to each other (as shown in FIG. 2). For example, in one of the transmitting antenna groups 101, 102, the electric field E1 of the transmitted signal of one of the transmitting antennas 10 oscillates in the vertical direction, while the electric field E2 of the transmitted signal of the other one of the transmitting antennas 10 oscillates in the horizontal direction.

In the following description, for the sake of simplicity, the four transmitting antennas 10 (as exemplified in this embodiment) are respectively referred to as a first transmitting antenna 11, a second transmitting antenna 12, a third transmitting antenna 13, and a fourth transmitting antenna 14. The first transmitting antenna 11 and the second transmitting antenna 12 are grouped together as a first transmitting antenna group 101. The third transmitting antenna 13 and the fourth transmitting antenna 14 are grouped together as a second transmitting antenna group 102. The transmitted signals respectively of the first transmitting antenna 11 and the second transmitting antenna 12 are orthogonal to each other. The transmitted signals respectively of the third transmitting antenna 13 and the fourth transmitting antenna 14 are orthogonal to each other. The transmitting-end direction of the polarization of any of the transmitting antennas 11, 12 included in the first transmitting antenna group 101 is not orthogonal to the transmitting-end direction of the polarization of any of the transmitting antennas 13, 14 included in the second transmitting antenna group 102. That is to say, the polarization of the transmitted signal of the first transmitting antenna 11 is orthogonal to neither the polarization of the transmitted signal of the third transmitting antenna 13 nor the polarization of the transmitted signal of the fourth transmitting antenna 14.

In this embodiment, the polarizations of the transmitted signals of the four transmitting antennas 11, 12, 13, 14 are respectively equal to 0 degrees, 90 degrees, -45 degrees, and 45 degrees, but the disclosure is not limited to such. In other embodiments, the transmitting-end directions of the transmitting antennas 10 may be adjusted according to user needs; for example, the polarizations of the transmitted signals of the four transmitting antennas 11, 12, 13, 14 may be respectively equal to 30 degrees, -60 degrees, 60 degrees, and -30 degrees. Moreover, in some embodiments, the MIMO communication system may be an 8x8 MIMO system, where there are eight transmitting antennas 10 that are grouped into four transmitting antenna groups, and the polarizations of the transmitted signals of the transmitting antennas 10 may be respectively equal to 0 degrees, 90 degrees, -45 degrees, 45 degrees, 30 degrees, -60 degrees, 60 degrees, and -30 degrees.

In this embodiment, each of the receiving antennas 20 has a polarization in a receiving-end direction, and is configured to receive the transmitted signal from one of the four transmitting antennas 11, 12, 13, 14, where the transmitted signal received by the receiving antenna 20 has a polarization in the transmitting-end direction that is identical to the receiving-end direction of the polarization thereof.

In the following description, for the sake of simplicity, the four receiving antennas 20 (as exemplified in this embodiment) are respectively referred to as a first receiving antenna 21, a second receiving antenna 22, a third receiving antenna 23, and a fourth receiving antenna 24.

Specifically, the receiving-end direction of the first receiving antenna 21 is identical to the transmitting-end direction of the first transmitting antenna 11; the receiving-end direction of the second receiving antenna 22 is identical to the transmitting-end direction of the second transmitting antenna 12; the receiving-end direction of the third receiving antenna 23 is identical to the transmitting-end direction of the third transmitting antenna 13; and the receiving-end direction of the fourth receiving antenna 24 is identical to the transmitting-end direction of the fourth transmitting antenna 14.

In this embodiment, each of the transmitting antennas 10 and the receiving antennas 20 may be, but is not limited to, a dipole antenna, a monopole antenna, a loop antenna, a planar inverted-F antenna, a patch antenna, or a microstrip antenna.

It should be noted that, for each of the transmitting antennas 10, a matching transmission path is formed between the transmitting antenna 10 and a matching one of the receiving antennas 20 that has the polarization in the receiving-end direction identical to the transmitting-end direction of the polarization of the transmitting antenna 10, and the transmitted signal transmitted by the transmitting antenna 10 propagates through the matching transmission path. It should be further noted that, for each of the transmitting antennas 10, a non-matching transmission path is formed between the transmitting antenna 10 and a non-matching one of the receiving antennas 20 that has the polarization in the receiving-end direction not identical to the transmitting-end direction of the polarization of the transmitting antenna 10.

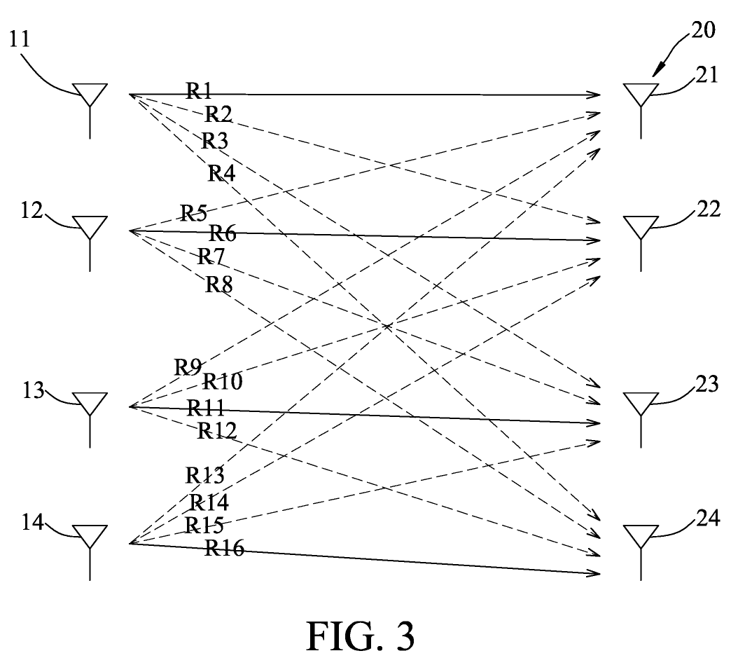

Referring further to FIG. 3, in the following description, for the sake of simplicity, the transmission paths formed between the first transmitting antenna 11 and the receiving antennas 21, 22, 23, 24 are respectively referred to as first to fourth signal transmission paths R1, R2, R3, R4; the transmission paths formed between the second transmitting antenna 12 and the receiving antennas 21, 22, 23, 24 are respectively referred to as fifth to eighth signal transmission paths R5, R6, R7, R8; the transmission paths formed between the third transmitting antenna 13 and the receiving antennas 21, 22, 23, 24 are respectively referred to as ninth to twelfth signal transmission paths R9, R10, R11, R12; the transmission paths formed between the fourth transmitting antenna 14 and the receiving antennas 21, 22, 23, 24 are respectively referred to as thirteenth to sixteenth signal transmission paths R13, R14, R15, R16.

The first signal transmission path R1, the sixth signal transmission path R6, the eleventh signal transmission path R11, and the sixteenth signal transmission path R16 are the matching transmission paths respectively of the transmitting antennas 11, 12, 13, 14. Each of the second to fifth signal transmission paths R2, R3, R4, R5, the seventh to tenth signal transmission paths R7, R8, R9, R10, and the twelfth to fifteenth signal transmission paths R12, R13, R14, R15 is the non-matching transmission path. To describe in further detail, the matching transmission path is a signal transmission path with the best signal-to-noise ratio (i.e., being least affected by noise) between the transmitting antenna 10 and the corresponding receiving antenna 20 thereof (that is, the transmitting-end direction of the transmitting antenna 10 is identical to the receiving-end direction of its corresponding receiving antenna 20).

The blocking device 3 may be disposed between the transmitting antennas 10 to block the non-matching transmission paths, and has a predetermined first dimension (H) along a propagation direction of the transmitted signals respectively transmitted by the transmitting antennas 10, and a predetermined second dimension (L) along a direction that is perpendicular to the propagation direction. In this embodiment, the blocking device 3 is disposed between the first transmitting antenna group 101 and the second transmitting antenna group 102.

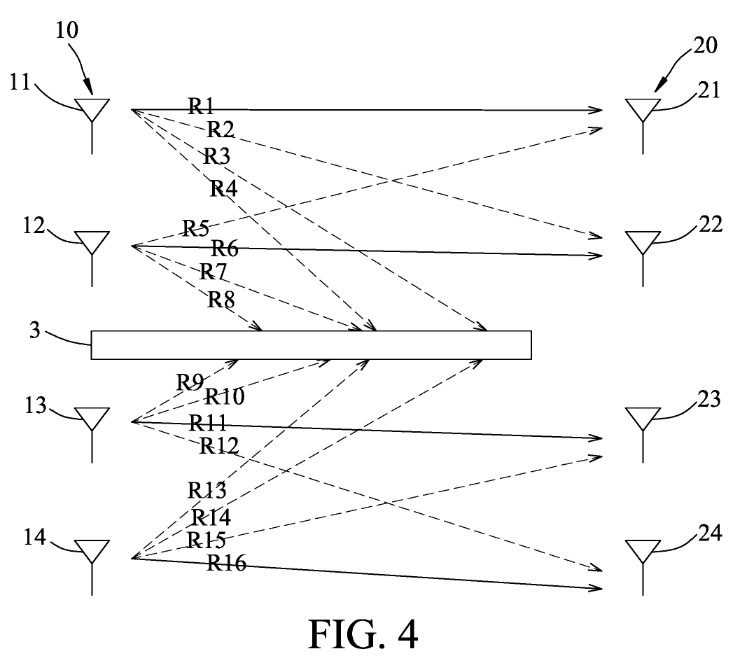

Referring further to FIG. 4, the first receiving antenna 21 is used as an example. The first receiving antenna 21 receives the transmitted signal that is transmitted by the first transmitting antenna 11 through the corresponding matching transmission path (i.e., the first signal transmission path R1), and other transmitted signals that propagate through the non-matching transmission paths (i.e., the fifth, ninth, and thirteenth signal transmission paths R5, R9, R13) are not received by the first receiving antenna 21. One reason is that the polarization of the transmitted signal propagating through the fifth signal transmission path R5 does not match the receiving-end direction of the polarization of the first receiving antenna 21, and another reason is that the transmitted signals propagating through the ninth signal transmission path R9 and the thirteenth signal transmission path R13 are blocked by the blocking device 3. As such, the transmitted signal received by the first receiving antenna 21 would be from the first transmitting antenna 11.

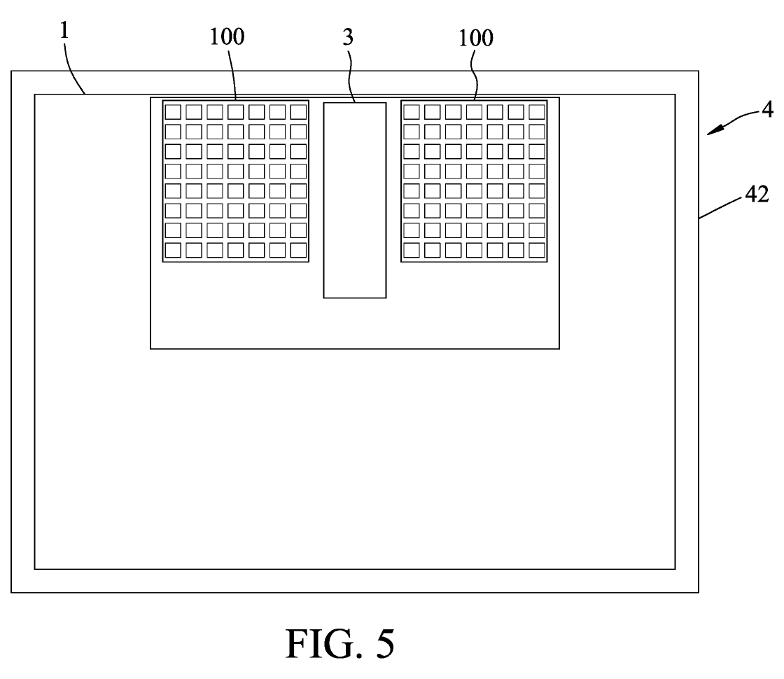

Referring further to FIG. 5, in some embodiments, the base station device 1 includes two antenna arrays 100 that serve as two transmitting groups, respectively. Each of the antenna arrays 100 includes a plurality of transmitting antennas. In such example, the blocking device 3 is disposed between the two antenna arrays 100.

It should be noted that the blocking device 3 may effectively block the non-matching transmission paths when a transmission distance (D) between the transmitting antennas 10 and the receiving antennas 20 is less than 100 m, when the predetermined first dimension (H) ranges from 4 cm to 5 cm, and when the predetermined second dimension (L) ranges from 10 cm to 13 cm. In this embodiment, the blocking device 3 may effectively block the non-matching transmission paths when the predetermined first dimension (H) is substantially equal to 4 cm while the transmission distance (D) is less than 100 m. In other embodiments, the predetermined first dimension (H) and the predetermined second dimension (L) may be adjusted according to design needs.

It should be further noted that the blocking device 3 has a shape of a board, and may be realized using radar wave absorbing materials, such as resin materials that include ferrite, but the disclosure is not limited to such.

In the embodiment shown in each of FIGS. 1 and 5, the housing 4 accommodates the transmitting antenna groups 101, 102 and the blocking device 3, and has six surfaces (only four can be seen in FIG. 1), which include a first surface 41 and a plurality of second surfaces 42 that are connected to the first surface 41. The first surface 41 is perpendicular to the propagation direction of the transmitted signals; that is, the transmitting antennas 10 face the first surface 41, and each of the transmitted signals respectively transmitted by the transmitting antennas 10 passes through the first surface 41 along its respective signal transmission path. In some embodiments, the blocking device 3 extends in a direction that is perpendicular to the first surface 41 of the housing 4 (i.e., the propagation direction). It should be noted that at least a portion of the second surfaces 42 is coated with an electromagnetic shielding layer for blocking electromagnetic waves. In one example, the electromagnetic shielding layer is coated on those of the second surfaces 42 that are parallel to a horizontal transmitted-end direction of the transmitting antennas 10. In another example, the electromagnetic shielding layer is coated on those of the second surfaces 42 that are parallel to a vertical transmitted-end direction of the transmitting antennas 10. As such, the electromagnetic shielding layer may reduce reflection or scattering of the transmitted signals, thereby reducing signal interference in the receiving antennas 20. It should be further noted that the electromagnetic shielding layer may also be realized using the abovementioned radar wave absorbing materials, but the disclosure is not limited to such.

In other embodiments, the first surface 41 may be contacted with the blocking device 3, which may sacrifice some of the coverage angle of the transmitting antennas 10 to further enhance the directivity of the transmitting antennas 10.

In summary, according to the disclosure, the blocking device 3 blocks at least some of the non-matching transmission paths, and the polarizations respectively of the transmitted signals transmitted by the transmitting antennas 10 of any one of the transmitting antenna groups 101, 102 are orthogonal to each other, so that each of the receiving antennas 20 would only receive the transmitted signal that is transmitted in the transmitted-end direction identical to the receiving-end direction thereof. As such, the correlation between the signal transmission paths among the transmitting antennas 10 of the base station device 1 and the receiving antennas 20 of the end user device 2 may be reduced, so as to prevent signal interference and to reduce the possibility of the receiving antennas 20 being unable to identify the transmitted signal or incorrectly decoding the transmitted signal due to interference.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A transmitting device of a multi-input multi-output (MIMO) communication system, adapted for communicating with a plurality of receiving antennas, each of the plurality of receiving antennas having a polarization in a receiving-end direction, said transmitting device comprising:
a plurality of transmitting antenna groups, each of said plurality of transmitting antenna groups including two transmitting antennas, each of said transmitting antennas having a polarization in a transmitting-end direction and being configured to transmit a transmitted signal with the polarization in the transmitting-end direction, where the transmitting-end direction of the polarization of one of said transmitting antennas included in one of said plurality of transmitting antenna groups is orthogonal to the transmitting-end direction of the polarization of another one of said transmitting antennas included in said one of said plurality of transmitting antenna groups; and
a blocking device disposed between said plurality of transmitting antenna groups and having a predetermined dimension along a propagation direction of the transmitted signals respectively transmitted by said transmitting antennas,
wherein, for each of said transmitting antennas, the transmitting-end direction of the polarization of the transmitted signal is identical to the receiving-end direction of the polarization of one of the plurality of receiving antennas;
wherein, for each of said transmitting antennas, a matching transmission path is formed between said transmitting antenna and a matching one of the plurality of receiving antennas that has the polarization in the receiving-end direction identical to the transmitting-end direction of the polarization of said transmitting antenna, and the transmitted signal transmitted by said transmitting antenna propagates through the matching transmission path,
wherein, for each of said transmitting antennas, a non-matching transmission path is formed between said transmitting antenna and a non-matching one of the plurality of receiving antennas that has the polarization in the receiving-end direction not identical to the transmitting-end direction of the polarization of said transmitting antenna, and
wherein said blocking device is configured to block the non-matching transmission path.

2. The transmitting device as claimed in claim 1, wherein said blocking device has a shape of a board, and the predetermined dimension ranges from 4 cm to 5 cm.

3. The transmitting device as claimed in claim 1, further comprising a housing that accommodates said plurality of transmitting antenna groups and said blocking device, and that includes a first surface perpendicular to the propagation direction of the transmitted signals, and a plurality of second surfaces connected to the first surface, said transmitting antennas facing the first surface,
wherein said blocking device extends in a direction that is perpendicular to said first surface of said housing, and
wherein at least a portion of said plurality of second surfaces is coated with an electromagnetic shielding layer for blocking electromagnetic waves.

4. A multi-input multi-output (MIMO) communication system, comprising:
said transmitting device as claimed in claim 1; and
a plurality of receiving antennas, each being configured to receive the transmitted signal with the polarization in the transmitting-end direction that is identical to the receiving-end direction of the polarization thereof.

5. The MIMO communication system as claimed in claim 4, wherein the transmitting-end direction of the polarization of any of said transmitting antennas included in one of said plurality of transmitting antenna groups is not orthogonal to the transmitting-end direction of the polarization of any of said transmitting antennas included in another one of said plurality of transmitting antenna groups.

6. The MIMO communication system as claimed in claim 4, wherein said blocking device has a shape of a board, and the predetermined dimension ranges from 4 cm to 5 cm.

7. The MIMO communication system as claimed in claim 4, further comprising a housing that accommodates said plurality of transmitting antenna groups and said blocking device, and that includes a first surface perpendicular to the propagation direction of the transmitted signals, and a plurality of second surfaces connected to the first surface, said transmitting antennas facing the first surface,
wherein said blocking device extends in a direction that is perpendicular to said first surface of said housing, and
wherein at least a portion of said plurality of second surfaces is coated with an electromagnetic shielding layer for blocking electromagnetic waves.
